(19) United States
(12) Patent Application Publication
(10) Pub. No.: US 2021/0092985 A1
(43) Pub. Date: Apr. 1, 2021

(54) A HEALTHY SOFT JELLY CANDY FORMULATION AND ITS PRODUCTION METHOD

(71) Applicant: SBS BILIMSEL BIO ÇÖZÜMLER SANAYI VE TICARET ANONIM SIRKETI, Istanbul (TR)

(72) Inventors: Asli Elif TANUGUR SAMANCI, Istanbul (TR); Taylan SAMANCI, Istanbul (TR)

(21) Appl. No.: 17/043,936

(22) PCT Filed: May 21, 2019
(86) PCT No.: PCT/TR2019/050352

§ 371 Date: Sep. 30, 2020

(30) Foreign Application Priority Data
Oct. 11, 2018 (TR) 2018/15120

(51) Int. Cl. A23L 21/15; A23G 3/42; A23G 3/44; A23G 3/48; A23L 21/20; A23L 29/231; A23L 33/105; A23L 33/15

(52) U.S. Cl. CPC A23L 21/15; A23G 3/42; A23G 3/44; A23L 33/15; A23L 21/20; A23L 29/231; A23L 33/105; A23G 3/48

(57) ABSTRACT

Disclosed is a healthy soft gel candy formulation containing water, gelling agent, honey, pollen, pure propolis extract, and at least one fruit extract, specially developed for the food industry, to meet the daily antioxidant needs of children and adults.

### TECHNICAL FIELD

The invention relates to a healthy soft jelly candy formulation and its production method.

The invention, specially concerning the food industry, relates to a healthy soft gel (jelly or jelly bone) formulation, comprising of pure propolis extract, bee pollen, honey, and fruit extracts without added fat, sugar, or preservatives, of which children and adults can easily consume for meeting their daily antioxidant needs and its production method.

### PRIOR ART

The main ingredient of a soft jelly candy product is gelatin, obtained from some animals, with some health benefits for bones and joints of the human body. This ingredient ensures that the jelly candy is flexible by lubricating. The gelatin extracted from the collagen, an animal protein, is obtained by denaturing it through hydrolysis. When collagen is boiled in water a water-soluble protein known as gelatine forms. Upon cooling this solution, it creates a gel structure that behaves like solid, although it is a liquid. Gelatin is an animal protein that is transparent, colorless, hard, crispy, tasteless, digestible, and soluble in hot water. The gelatin consists of 86% collagen, 11% water, and 3% mineral substances.

Soft jelly candies in the market today contain high amounts of sugar, preservative, and additives. The presence of a high volume of sugar and additives lets those snack foods to be perceived as unhealthy products for the consumption of adults and children. Excessive use of such products can lead to many diseases such as obesity, diabetes, or fatty liver syndrome concerning weight gain.

In the literature, about soft jelly candy products, the following applications were found:

The patent application no. TR2015/08312 relates to a soft jelly candy (gummy candy) product developed for increasing the shelf life of the apricot fruit and expanding its use in the food industry based on a formulation of fresh or dried apricots as primary raw material and sugar and glucose syrup, which follows molding for the final shape. For the production of apricot jelly candy, either fresh apricots or sun-dried apricots can be used. Also, the detailed description indicated that food colors and preservatives are also used in the formulation. Due to the presence of sugar, glucose syrup, colors, and preservatives in the present invention, this product presents health concerns.

Another invention is cited in a patent application no. JP2000245363 (A), entitled “Honey Jelly and its Production Method.” According to the invention, honey is used as a sweetener and phosphoric acid as a pH regulator. Although honey is used instead of sugar in the said invention, the presence of phosphoric acid as a chemical additive, the product brings about health concerns.

As a result, due to the drawbacks about health issues and the inadequacy of the existing solutions, an improvement in the technical field is necessary.

### BRIEF DESCRIPTION OF THE INVENTION

The present invention relates to a healthy soft jelly candy formulation and its production method that meets the requirements as mentioned above, eliminates all disadvantages and brings some additional advantages.

The primary purpose of the invention is to develop a soft jelly candy product with no added sugar, no chemical additive, and no preservative, as an alternative to other soft jelly or gummy candies containing high amounts of sugar, preservatives, and additives in the current market.

A further purpose of the invention is to make a delicious and healthy soft jelly candy product to meet the daily antioxidant needs of adults and children.

Another purpose of the invention is to provide a soft jelly candy with high antioxidant, antibacterial, antiviral and antifungal properties due to the addition of pure propolis extract into its formula. For achieving the above purposes, the proposed healthy soft jelly candy formulation comprises water, a gelling agent, honey, bee pollen, pure propolis extract, and at least one fruit extract.

For achieving the purposes of the invention, the soft jelly candy formulation comprises 50-65% w/w water, 18-30% w/w gelling agent, 5-20% w/w honey, 2-10% w/w pollen, 2-10% w/w pure propolis extract, and at least one 1-5% w/w fruit extract.

For achieving the purposes of the invention, the soft jelly candy composition comprises an average of 58% w/w water, 20% w/w gelling agent, 10% w/w honey, 5% w/w bee pollen, 5% w/w pure propolis extract, and 2% w/w fruit extract.

For achieving the purposes of the invention, the soft jelly candy composition might additionally contain a different plant extract, vitamin(s) and/or mineral(s) according to preference.

For achieving the purposes of the invention, soft jelly candy production method comprises following process steps;
Adding the gelling agent into the boiling water, and mixing it thoroughly until it is completely dissolved (101),
Chilling the obtained mixture in the cold water bath by stirring continuously (102),
Continue to stirring the cooled mixture after adding honey, pollen, pure propolis extract, and at least one fruit extract (103),
Removing the air bubbles by decanting the mixture into suitable molds (104),
cooling of the molds (105),
removing of the products from molds (106),
Blending and packaging of the final products removed from the molds (107).

The fundamental characteristics and all advantages of the invention outlined in the drawings below and the detailed descriptions by referring these figures will help a thorough understanding of the invention; therefore, the evaluation of invention needs the attention of both figures and the specific explanations together.

### BRIEF DESCRIPTION OF THE FIGURES

FIG. 1 represents the process steps of the invention, namely soft jelly candy, production.

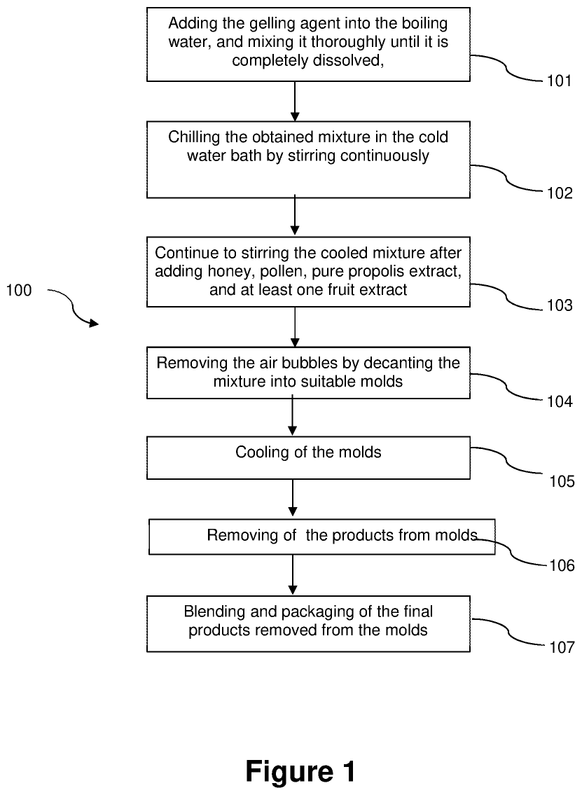

There is no need to scale the given drawings and details that are not necessary to comprehend the invention may be ignored. Other than that, elements that are substantially identical, or at least dramatically have similar functions, are denoted by the same number.

### DESCRIPTION OF REFERENCE

100—Soft jelly production method
101—Adding the gelling agent into the boiling water, and mixing it thoroughly until it is completely dissolved,
102—Chilling the obtained mixture in the cold water bath by stirring continuously,
103—Continue to stirring the cooled mixture after adding honey, pollen, pure propolis extract, and at least one fruit extract,
104—Removing the air bubbles by decanting the mixture into suitable molds,
105—cooling of the molds,
106—Removing of the products from molds,
107—Blending and packaging of the final products removed from the molds.

### DETAILED DESCRIPTION OF THE INVENTION

In this detailed description of the invention, a healthy soft jelly candy formulation and its production method have been disclosed solely for a better understanding of the invention and for not causing any conflict.

The invention, specific for the food industry, is about a healthy soft jelly candy (gummy candy) formulation that contains water, gelling agent, honey, bee pollen, pure propolis extract, and at least one fruit extract and its production method. Table-1 below shows the contents of the invention of soft jelly candy and proper addition amounts.

TABLE 1
Sample composition of soft jelly

| | Preferred Quantity | Usable Quantity By |
|---|---|---|
| Content | By Weight (%) | Weight (%) |
| Water | 58 | 50-65 |
| Gelling agent | 20 | 18-30 |
| Honey | 10 | 5-20 |
| Bee Pollen | 5 | 2-10 |
| Pure propolis extract | 5 | 2-10 |
| Fruit Extracts | 2 | 1-5 |

The gelling agent(s) used in the invention of soft jelly candy formulation are either single or a combination of gelatin, pectin, starch, alginate, carboxymethyl cellulose (CMC), agar, gum arabic, guar gum, and gum tragacanth.

Different fruit and plant extracts/juices can be added to the delicious and healthy jelly product to meet the daily antioxidant needs of adults and children. Furthermore, the addition of various vitamins and minerals may enrich the product variety. By keeping the principles in developing a healthy food product without the addition of preservative and additives, jelly and similar coatings can also be applied to these products.

In the invention of soft jelly candy formulation, gelling agents suitable for halal consumption of animal or vegetable origin are used as thickeners. The only sweetener is raw honey without any other source of sweetener. Moreover, there is no aroma addition in the formulation as various natural fruit extracts of which the children would love provide the flavor.

There is no chemical coloring in the soft jelly candy formulation invention. Natural fruit extracts, bee pollen, and pure propolis extract in the formulation provide the natural color of the product.

In the present invention, the product is preserved throughout its shelf life, without any need for a chemical additive or a preservative, by the action of pure propolis extract obtained via an extraction method following its harvest from the hive. Due to the high antioxidant, antibacterial, antiviral, and antifungal properties of pure propolis extract, there is no need for the addition of any chemical additive or preservative in the invention. Consequently, the invention will be available in the market as a healthy alternative to current sweet jelly products.

The process steps of the soft jelly production method (100) are listed below:
Adding the gelling agent into the boiling water, and mixing it thoroughly until it is completely dissolved (101)
Chilling the obtained mixture in the cold-water bath by stirring continuously (102),
Continue to stirring the cooled mixture after adding honey, pollen, pure propolis extract, and at least one fruit extract (103),
Removing the air bubbles by decanting the mixture into suitable molds (104),
Cooling of the molds (105),
Removing of the products from molds (106),
Blending and packaging of the final products removed from the molds (107).

It is a must to adding the gelling agent into the boiling water , and mixing it thoroughly until it is completely dissolved (101); if the agent is not thoroughly melted and mixed, it is not possible to reach the desired consistency. The mixing time is around 8 to 15 minutes, depending on the amount of the gelling agent.

The mixture obtained in the process step (102) is cooled to a temperature in the range of 55-45° C. The reason for cooling that mixture in a cold-water bath (102) is to protect the product exposing to high temperatures since the primary idea is to offer a product without degrading all the precious nutritional value of honey, bee pollen, propolis, and fruit extracts.

In the process step 104, degassing is applied for 5-15 minutes. Degassing process (104) is required for the removal of air bubbles in the product to ensure that the product has a perfect appearance. In the process step 105, the molds are cooled to 5-15° C. Cooling of the molds (105) process is applied to remove the final product from the mold. In the process step .107, products containing different fruit extracts are blended and packaged.

1. Soft jelly or gummy candy formulation, specially developed for the food industry to meet daily antioxidant needs of adults and children with the addition of water and a gelling agent is characterized by comprising:; honey, pollen, pure propolis extract, and at least one fruit extract.

2. Soft jelly or gummy candy formulation according to claim 1, characterized by comprising:;
50-65% w/w water, 18-30% w/w gelling agent, 5-20% w/w honey, 2-10% w/w bee pollen, 2-10% w/w pure propolis extract, and at least one fruit extract at a ratio of 1-5% w/w.

3. Soft jelly or gummy candy formulation according to claim 2, characterized by comprising: average of 58% w/w water, 20% w/w gelling agent, 10% w/w honey, 5% w/w bee pollen, 5% w/w pure propolis extract, and 2% w/w fruit extract.

4. Soft jelly or gummy candy formulation according to claim 1, characterized by comprising: at least one plant extract vitamins and/or minerals.

5. Soft jelly or gummy candy formulation according to claim 1, characterized by comprising: the gelling agent(s) used singly or in combinations selected from the group of gelatin, pectin, starch, alginate, carboxymethyl cellulose, agar, gum arabic, guar gum, gum tragacanth.

6. Soft jelly or gummy candy production method according to claim 1, characterized by comprising following steps:
adding the gelling agent into the boiling water, and mixing it thoroughly until it is completely dissolved;
chilling the obtained mixture in the cold-water bath by stirring continuously;
continue to stirring the cooled mixture after adding honey, pollen, pure propolis extract, and at least one fruit extract;
removing the air bubbles by decanting the mixture into suitable molds; and
cooling of the molds.

7. A method according to claim 5, characterized by comprising process steps below following the process step of cooling of the molds:
removing of the products from molds; and
blending and packaging of the final products removed from the molds.

8. A method according to claim 5, wherein the mixing time for the gelling agent in the boiling water is around 8 to 15 minutes.

9. A method according to claim 5, wherein the mixture chilled in the cold-water bath is cooled to a temperature range of 55-45° C.

10. A method according to claim 5, wherein the degassing process of removing the air bubbles is applied around 5 to 15 minutes.

11. A method according to claim 5, wherein the molds are cooled to a temperature range of 5-15° C. in the step of cooling of the molds.
